(19) United States
(12) Patent Application Publication
(10) Pub. No.: US 2021/0017350 A1
(43) Pub. Date: Jan. 21, 2021

(54) SHOE COMPONENT PRETREATMENT SOLUTION AND PRETREATMENT METHOD USING SOLUTION

(71) Applicant: ORISOL TAIWAN LIMITED., Chang Hwa (CN)

(72) Inventors: Michael LETUCHI, Yavne (IL); Tanya MILLER, Yavne (IL)

(21) Appl. No.: 16/603,238

(22) PCT Filed: Apr. 20, 2017
(86) PCT No.: PCT/CN2017/081210

§ 371 Date: Oct. 7, 2019

(51) Int. Cl. C08J 7/14; C08J 5/12; C09K 13/06; A43D 11/14

(52) U.S. Cl. CPC C08J 7/14; C08J 5/12; C08J 2321/00; A43D 11/14; C09K 13/06

(57) ABSTRACT

Provided are a shoe component pretreatment solution and a pretreatment method using the solution, wherein the shoe component pretreatment solution comprises an acidic compound, a salt compound, an surfactant and water. The present invention involves applying the shoe component pretreatment solution to a rubber sole, thereby shortening the process of the pretreatment step, and avoids the use of any MEK organic solvents and also avoids the generation of suspended particulates caused by grinding, thus eliminating harm to the human body and the environment, and reducing the costs in terms of time and money.

### BACKGROUND OF THE INVENTION

### Field of the Invention

The present invention relates to a method for manufacturing shoes, and more particularly to a shoe component pretreatment solution and pretreatment method using solution.

### Related Prior Art

Conventional shoe manufacturing methods usually involve many steps and procedures. One of the methods is to attach the sole made of rubber material to the upper and bond them together, and the upper mentioned above can be made of any material known in the art, such as EVA (ethylene-vinyl acetate), PU (Polyurethane), synthetic leather, leather or fabric, etc.

In order to make the bonding between the rubber sole and the upper reliable and secure, it is necessary to pretreat the rubber sole, and the pretreatment is shown in FIG. 1, including: a step X of polishing, a step Y of degreasing and a step Z of priming.

The surface of rubber material is usually susceptible to oxidation, and therefore can not react well with chemicals, and as a result, the rubber sole and the upper made of other materials can not be effectively and reliably bonded together, therefore, polishing is the first pretreatment step.

The conventional step X of polishing is achieved by mechanical polishing. The purpose of polishing is two-fold, one is to scrape and remove the rubber oxidized surface, and the other is to roughen the sole surface to increase the potential adhesion area.

However, in the process of polishing, mechanical grinding will produce rubber powder which will be scattered in the air, resulting in environmental pollution and harm to human health.

Furthermore, the polishing process is both time-consuming and tiring, and only skilled workers are able to perform polishing smoothly. Therefore, the polishing process is a costly process.

The next step after the polishing step X is the step Y of degreasing, which is a necessary step to dissolve oily substances and remove residue impurities from the rubber surface, the degreasing step may use Loctite's “Natural Blue” chemicals, which are known products in the art, therefore no further explanation seems necessary.

The next step Z of priming is used to chlorinate and polarize the rubber surface, thereby improving the bonding and adhesion performance of the polyurethane adhesive used in the subsequent steps, however, the primer in the priming step is a MEK based (methyl ethyl ketone) solution of trichloroisocyanuric acid, the solution is volatile and has a negative impact on the environment and human body.

It is learned from the foregoing that the respective pretreatment procedures require skilled manpower, expensive equipment and chemicals, resulting in high cost, environmental pollution, harm to human health, time-consuming and so on.

The present invention has arisen to mitigate and/or obviate the afore-described disadvantages.

### SUMMARY

One objective of the present invention is to provide a shoe component pretreatment method capable of reducing pretreatment procedures, eliminating harm to the human body and the environment, and reducing the time and money cost.

Another objective of the present invention is to provide a pretreatment solution used in the pretreatment method.

To achieve the above objective, a shoe component pretreatment solution in accordance with the present invention comprises:

acidic compound;

salt compound;

surfactant; and

water.

Preferably, the shoe component pretreatment solution comprises:

0.25-10 wt % of said acidic compound;

0.5-15 wt % of said salt compound;

0.05-1.5 wt % of said surfactant; and

a proper amount of said water making the sum of said acid compound, salt compound, water, surfactant equal to 100%.

A shoe component pretreatment method using the pretreatment solution in accordance with the invention comprises the following steps:

a step of degreasing including cleaning a rubber surface by dissolving oily substances and removing residue impurities from the rubber surface; and

a step of applying the pretreatment solution to rubber shoe components including applying the pretreatment solution to the rubber surface, wherein the pretreatment solution will experience chlorination and polarization when contacting rubber polymer.

It can be learned from the above description that the pretreatment solution and the shoe component pretreatment method in accordance with the invention can reduce the pretreatment procedures, avoid the use of MEK organic solvent, also prevent suspended particles produced by grinding process, consequently eliminating harm to the human body and the environment, and reducing the time and money cost.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a flow chart of a conventional shoe component pretreatment solution; and

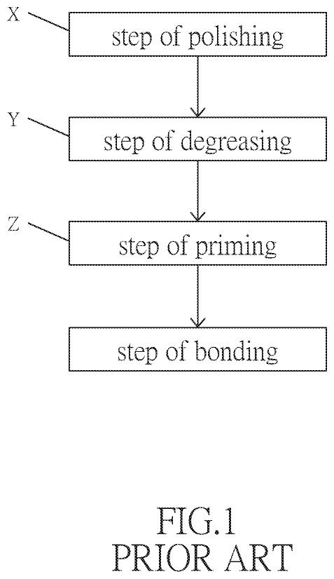

FIG. 2 is a flow chart of the shoe component pretreatment method in accordance with the invention.

### DETAILED DESCRIPTION

The present invention will be clearer from the following description when viewed together with the accompanying drawings, which show, for purpose of illustrations only, the preferred embodiment in accordance with the present invention.

A shoe component pretreatment solution in accordance with the present invention is an environmental friendly aqueous chemical solution and contains surfactant, acid compound and salt compound. The shoe component pretreatment solution in accordance with a preferred embodiment of the present invention contains the follows:

0.25-10 wt % of acidic compound and the acidic compound can be hydrochloric acid (HCl) or sulfuric acid (H₂SO₄);

0.5-15 wt % of salt compound, which can be Sodium hypochlorite (NaOCl), Sodium dichloroisocyanurate (C₃Cl₂N₃NaO₃), N-Chlorosuccinimide (C₄H₄ClNO₂);

0.05-1.5 wt % surfactant, and the surfactant can be BYK307, BYK348, Capstone FS-51, Triton 100 and other, which are the type number of the surfactant known in the art, so their contents are omitted.

A proper amount of water makes the sum of the four (acid compound, salt compound, water, surfactant) equal to 100%.

The above is the preferred embodiment of the shoe component pretreatment solution and is not used to limit the invention, any chemical dissolution with similar activity as the abovementioned shoe component pretreatment solution fall within the scope of the present invention.

The shoe component pretreatment solution in accordance with the invention is capable of chlorination and polarizing the rubber surface to increase surface roughness, and can produce more adhesive rough areas, which makes the bonding between the sole and the upper more reliable and durable.

The aforementioned upper can be made from any known material in the field, such as EVA (ethylene vinyl acetate), PU (polyurethane), synthetic leather, leather or fabric, etc.

The shoe component pretreatment solution in accordance with the present invention is an aqueous solution; therefore need to add surfactant to improve rubber wetting, so that the shoe component pretreatment solution can be diffused through the surface of the sole in the most even manner.

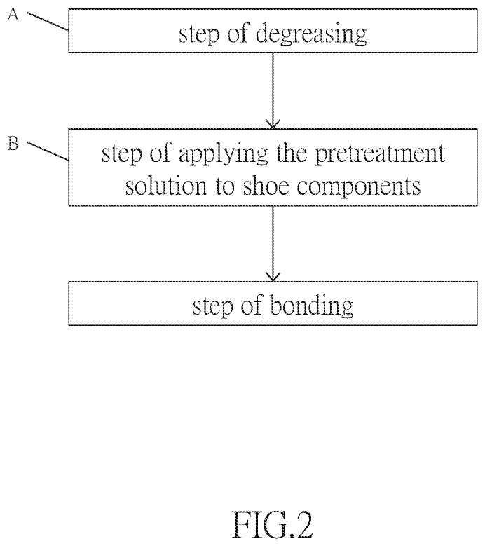

A shoe component pretreatment method provided by the invention is shown in FIG. 2, and comprises the following steps:

a step A of degreasing: includes cleaning rubber surface by dissolving oily substances and removing residue impurities from the rubber surface; and

a step B of applying a pretreatment solution to rubber shoe component, wherein the pretreatment solution stays on the rubber shoe component (rubber sole) for 1 to 5 minutes, and the pretreatment solution will result in chlorination and polarization when it contacts the rubber polymer.

In a preferred embodiment, the step of applying pretreatment solution to rubber shoe components is to immerse the rubber sole into the pretreatment solution.

In another preferred embodiment, the step of applying pretreatment solution to shoe components is to apply the pretreatment solution to the rubber surface by spraying or brushing.

The rubber shoe component pretreated with pretreatment solution is ready for following gluing.

The present invention uses the step of applying pretreatment solution to shoe components to replace the conventional polishing and priming steps.

The shoe component pretreatment method in accordance with the invention has been applied and tested on 20 different types of shoe rubbers (including Adidas, Nike, new balance and Asics footwear rubbers). The test results show that the bonding between the rubber and the bonding agent has a very strong adhesive force, the peeling force falls in the range of 47 N/cm to 81 N/cm, and the following tests clearly show the reliability of the shoe component pretreatment solution of the invention.

First, use the 20% POE-CMP EVA material made by Paochen industrial RPE plant as the upper, and use the below pre-bonding EVA standard procedures:

EVA degreasing→applying with UV33 primer (produced by Nanpao)→Ultraviolet activation→bonding with adhesive

There are two ways to bond the rubber sole and the EVA upper, which are explained as follows:

Bonding technology A: powder technology;

a. providing a rubber pretreated by the pretreatment method for shoe components of the invention, and applying the rubber with Arteprimer 206 (a product of Orisol Asia);

b. using a powder machine (model OPS 410, a machine made by Orisol Asia) to apply polyurethane powder (a product of Orisol Asia, Artepowder 7080) to the rubber;

c. providing an EVA (ethylene vinyl acetate) material processed by the above standard procedures, and coating the EVA material with Arteprimer 206; and

d, heating and activating the aforementioned EVA material and rubber material until their surface temperature reach 90° C., and providing a pressure of 20 kg/sq.cm. with a machine.

Bonding technology B: water-based bonding technology:

a, applying water-based polyurethane adhesive to lateral surfaces of the EVA material and the rubber material; and

b, heating and activating the aforementioned EVA material and rubber material until their surface temperature reach 90° C., and providing a pressure of 20 kg/sq.cm. with a machine.

In a first embodiment:

Degreasing with a first rubber→spraying the pretreatment solution of the invention onto the first rubber for 5 minutes→drying→bonding with the abovementioned bonding technology A→peeling test was made 24 hours after the rubber sole and the EVA upper material were bonded together, and the measured peeling force is 47 N/cm.

The abovementioned shoe component pretreatment solution contains:

1 wt % HCl;

2 wt % NaOCl;

96.9 wt % H₂O; and

0.1 wt/% surfactant (Capstone FS-51).

In a second embodiment:

Degreasing with a second rubber→spraying the pretreatment solution of the invention onto the second rubber for 5 minutes→drying→bonding with the above-mentioned bonding technology A→peeling test was made 24 hours after the rubber sole and the EVA upper material were bonded together, and the measured peeling force is 60 N/cm.

The abovementioned shoe component pretreatment solution contains:

1 wt % HCl;

2 wt % NaOCl;

96.9 wt % H₂O; and

0.1 wt/% surfactant (Capstone FS-51).

In a third embodiment:

Degreasing with a second rubber→immerse the second rubber into the pretreatment solution of the invention for 5 minutes→drying→bonding with the abovementioned bonding technology B→peeling test was made 24 hours after the rubber sole and the EVA upper material were bonded together, and the measured peeling force is 61 N/cm.

The abovementioned shoe component pretreatment solution contains:

1 wt % HCl;

2 wt % NaOCl;

96.9 wt % H₂O; and

0.1 wt/% surfactant (Capstone FS-51).

In a fourth embodiment:

Degreasing with a second rubber→spraying the pretreatment solution of the invention onto the second rubber for 1 minutes→drying→bonding with the abovementioned bonding technology B→peeling test was made 24 hours after the rubber sole and the EVA upper material were bonded together, and the measured peeling force is 55 N/cm.

The abovementioned shoe component pretreatment solution contains:

1 wt % HCl;

2 wt % NaOCl;

96.8 wt % H₂O; and

0.2 wt/% surfactant (BYK307).

In a fifth embodiment:

Degreasing with a third rubber→spraying the pretreatment solution of the invention onto the third rubber for 1 minutes→drying→bonding with the abovementioned bonding technology B→peeling test was made 24 hours after the rubber sole and the EVA upper material were bonded together, and the measured peeling force is 30 N/cm.

The abovementioned shoe component pretreatment solution contains:

2 wt % HCl;

4 wt % NaOCl;

93.8 wt % H₂O; and

0.2 wt/% surfactant (BYK307).

In a sixth embodiment:

Degreasing with a third rubber→spraying the pretreatment solution of the invention onto the third rubber for 5 minutes→drying→bonding with the abovementioned bonding technology B→peeling test was made 24 hours after the rubber sole and the EVA upper material were bonded together, and the measured peeling force is 81 N/cm.

The abovementioned shoe component pretreatment solution contains:

0.5 wt % H₂SO₄;

2 wt % NaOCl;

97.3 wt % H₂O; and

0.2 wt/% surfactant (BYK308).

In a seventh embodiment:

Degreasing with a fourth rubber→immersing the fourth rubber into the pretreatment solution of the invention for 5 minutes→drying→bonding with the abovementioned bonding technology B→peeling test was made 24 hours after the rubber sole and the EVA upper material were bonded together, and the measured peeling force is 47 N/cm.

The abovementioned shoe component pretreatment solution contains:

1 wt % HCl;

2 wt % C₃Cl₂N₃NaO₃;

96.8 wt % H₂O; and

0.2 wt/% surfactant (BYK307).

In the above respective embodiments, the drying step is carried out at 55° C. for 5 minutes, but the invention is not limited to this.

It can be learned from the above description that the pretreatment solution and the shoe component pretreatment method in accordance with the invention can reduce the pretreatment procedures, avoid the use of MEK organic solvent, also prevent suspended particles produced by grinding process, consequently eliminating harm to the human body and the environment, and reducing the time and money cost.

While we have shown and described various embodiments in accordance with the present invention, it is clear to those skilled in the art that further embodiments may be made without departing from the scope of the present invention.

What is claimed is:

1. A shoe component pretreatment solution, comprising:
acidic compound;
salt compound;
surfactant; and
water.

2. The shoe component pretreatment solution as claimed in claim 1 comprising:
0.25-10 wt % of said acidic compound;
0.5-15 wt % of said salt compound;
0.05-1.5 wt % of said surfactant; and
a proper amount of said water making the sum of said acid compound, salt compound, water, surfactant equal to 100%.

3. The shoe component pretreatment solution as claimed in claim 1, wherein the acidic compound is hydrochloric acid (HCl) or sulfuric acid (H₂SO₄).

4. The shoe component pretreatment solution as claimed in claim 2, wherein the acidic compound is hydrochloric acid (HCl) or sulfuric acid (H₂SO₄).

5. The shoe component pretreatment solution as claimed in claim 1, wherein the salt compound is selected from the group consisting of Sodium hypochlorite (NaOCl), Sodium dichloroisocyanurate (C₃Cl₂N₃NaO₃) and N-Chlorosuccinimide (C₄H₄ClNO₂).

6. The shoe component pretreatment solution as claimed in claim 2, wherein the salt compound is selected from the group consisting of Sodium hypochlorite (NaOCl), Sodium dichloroisocyanurate (C₃Cl₂N₃NaO₃) and N-Chlorosuccinimide (C₄H₄ClNO₂).

7. A shoe component pretreatment method by using the pretreatment solution as claimed in claim 1 comprising the following steps:
a step of degreasing including cleaning a rubber surface by dissolving oily substances and removing residue impurities from the rubber surface; and
a step of applying the pretreatment solution to shoe components including applying the pretreatment solution to the rubber surface, wherein the pretreatment solution will experience chlorination, polarization and decomposition when contacting rubber polymer.

8. The shoe component pretreatment method as claimed in claim 7, wherein the step of applying pretreatment solution to shoe components is to apply the pretreatment solution to the rubber surface by spraying or brushing, or by immersing the rubber surface into the pretreatment solution.

9. The shoe component pretreatment method as claimed in claim 7, wherein the step of applying pretreatment solution to shoe components is carried out automatically or manually.
